(19) United States
(12) Patent Application Publication
(10) Pub. No.: US 2018/0186608 A1
(43) Pub. Date: Jul. 5, 2018

(54) Lifting Device for Precast Concrete Structures

(71) Applicant: Albert Mancini, Pompano Beach, FL (US)

(72) Inventor: Albert Mancini, Pompano Beach, FL (US)

(21) Appl. No.: 15/863,829

(22) Filed: Jan. 5, 2018

Related U.S. Application Data
(60) Provisional application No. 62/442,782, filed on Jan. 5, 2017.

(51) Int. Cl. B66C 1/42

(52) U.S. Cl. CPC B66C 1/427; E04B 1/04

(57) ABSTRACT

A lifting device for precast concrete structures allows a crane to securely lift and transport a concrete structure for to a desired position. The lifting device includes a structural hub, a plurality of gripping mechanisms, and a hitch system. The structural hub radially distributes the plurality of gripping mechanisms about the flange, creating multiple contact points for dividing the vertical load. The plurality of gripping mechanisms laterally and vertically braces the flange, thereby centering the concrete structure to the structural hub. The hitch system allows tethers a crane to the structural hub which provides the primary vertical lifting force. Each of the plurality of gripping mechanisms includes a sleeve, an extension arm, a linear actuator, and a gripper. The linear actuator extends and retracts extension arm out of the sleeve. Finally, the gripper is designed to fasten the flange in a secure manner.

The current application claims a priority to the U.S. Provisional Patent application Ser. No. 62/442,782 filed on Jan. 5, 2016.

### FIELD OF THE INVENTION

The present invention generally relates to lifting device for precast concrete structure. More specifically, a plurality of gripping mechanisms mounted onto a structural hub grips onto an overhanging flange of a concrete structure, thereby allowing the concrete structure to be lifted and transported to the desired position.

### BACKGROUND OF THE INVENTION

Conventional concrete rigging methods are too laborious and cumbersome to be useful in today's high demand construction schedules. In particular, conventional rigging methods are prohibitively time-consuming and wholly unsuited for many construction applications. Thus, there is a demand for a more efficient and time-efficient method and apparatus for handling concrete capable of meeting the ever-increasing demands from businesses for efficiency and improvement. The present invention offers a solution to this the laborious process of rigging and lifting cylindrical concrete structures by introducing a crane mounted gripper that can easily be lowered onto the concrete structure. The gripper uses a plurality of gripping mechanisms to releasably brace an overhanging flange of the concrete structure.

Though there are circular grippers on the market, they are too small and lack features that would allow for lifting of larger, heavier articles and further lack a means to connect to a crane or similar devices used for lifting concrete based equipment. To remedy this, the present invention the plurality of gripping mechanisms can be extended or retracted in order to adjust the overall span of the gripper, as may be necessary to brace concrete structures of different sizes.

The present invention preferably uses a pneumatic drive mechanism to allow the user to selectively apply pressure to a retraction line, or an extension line that simultaneously actuates the plurality of gripping mechanisms. An operator controls the gripper with a hand-held controller that allows the gripper to be operated from a safe distance, while allowing the operator to quickly and accurately move the concrete structure.

### BRIEF DESCRIPTION OF THE DRAWINGS

FIG. 1 is a front perspective view of the present invention with the plurality of grippers in the retracted configuration.

FIG. 2 is a schematic illustrating the fluid connections between the linear actuator of the plurality of gripping mechanisms, the valve, and the pressure generator.

FIG. 3 is a top view of the present invention with the plurality of grippers in the retracted configuration.

FIG. 4 perspective cross-section of the linear actuators of two of the gripping mechanisms in the retracted configuration taken along line 4-4 in FIG. 3.

FIG. 5 perspective cross-section of the linear actuators of two of the gripping mechanisms in the extended configuration taken along line 4-4 in FIG. 3.

FIG. 6 is an elevational perspective view of the present invention.

FIG. 7 is a detail view of circle 7 in FIG. 4 illustrating the linear actuator in the retracted configuration.

FIG. 8 is a detail view of circle 8 in FIG. 5 illustrating the linear actuator in the extended configuration.

FIG. 9 is a detail view of circle 9 in FIG. 1 illustrating the hitch system.

FIG. 10 is a detail view of circle 10 in FIG. 6 illustrating the gripper.

### DETAILED DESCRIPTION OF THE INVENTION

All illustrations of the drawings are for the purpose of describing selected versions of the present invention and are not intended to limit the scope of the present invention.

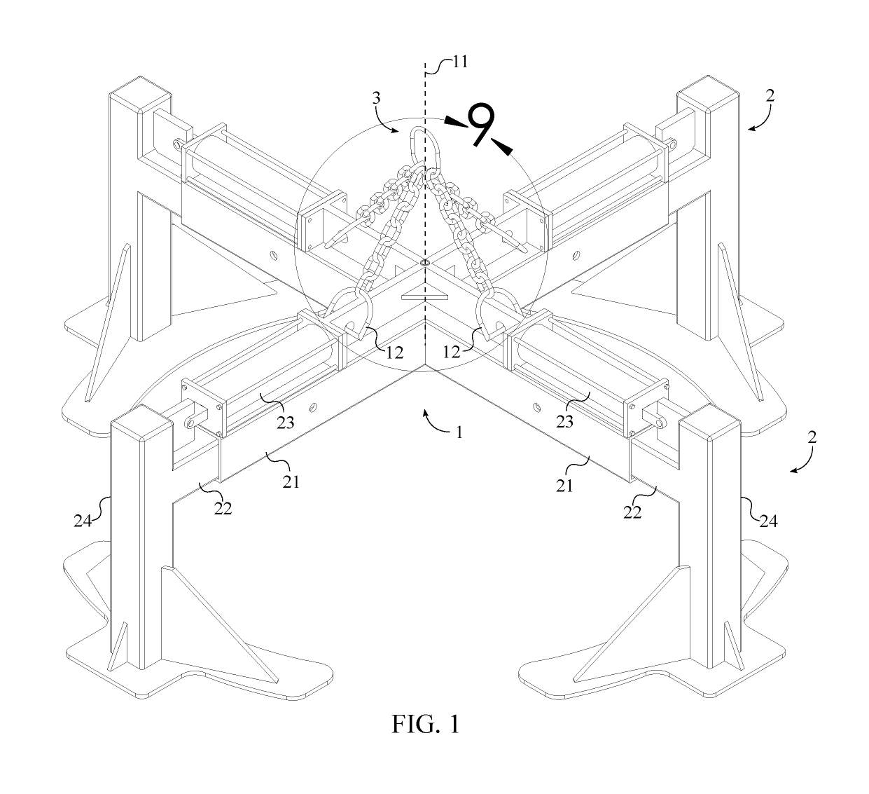

In reference to FIG. 1, the present invention is a lifting device for precast concrete structures that selectively fastens onto the flange vertically lifts the concrete structure. More specifically, the present invention uses a novel lifting mechanism that distributes vertical lifting forces around the flange to minimize the potential damage to the concrete structure. The preferred embodiment of the present invention comprises a structural hub 1, a plurality of gripping mechanisms 2, and a hitch system 3. The hitch system 3 fastens a rope or strap to the structural hub 1 for vertically lifting the present invention. The plurality of gripping mechanisms 2 securely attached the structural hub 1 to the flange of the concrete structure, thereby securely connecting the concrete structure to the present invention. Accordingly, each of the plurality of gripping mechanisms 2 comprises a sleeve 21, an extension arm 22, a linear actuator 23, and a gripper 24. The plurality of gripping mechanisms 2 is radially positioned around the central axis 11 of the structural hub 1. As a result, the plurality of gripping mechanisms 2 supports the flange at multiple contact points and prevents excessive force being applied at any single point.

The central axis 11 traverses through the structural hub 1 and is longitudinally aligned to the concrete structure. Preferably, the structural hub 1 is terminally and laterally connected to the sleeve 21. Additionally, the sleeve 21 is positioned perpendicular to the central axis 11 of the structural hub 1. As such, the vertical load is equally distributed about the plurality of gripping mechanisms 2. The extension arm 22 is slidably mounted into the sleeve 21, opposite the structural hub 1, which allows the extension arm 22 to extend and retract into and out of the sleeve 21. In the preferred implementation of the present invention, the extension arm 22 must extend out of the sleeve 21 to fit the flange inside the plurality of gripping mechanisms 2. Once the flange is fitted inside the plurality of gripping mechanisms 2, the extension arm 22 retracts into the sleeve 21 and the gripper 24 engages the flange. Accordingly, the gripper 24 is terminally connected to the extension arm 22, offset from the sleeve 21. Thus, the extension arm 22 retracts until the gripper 24 slides below the flange, thereby allowing the gripper 24 to vertically support the concrete structure. The preferred embodiment of the present invention utilizes the linear actuator 23 to extend and retract the extension arm 22 out of and into the sleeve 21. Accordingly, a fixed end 233 of the linear actuator 23 is laterally connected to the sleeve 21. Further, an actuation end 234 of the linear actuator 23 is laterally connected to the extension arm 22. In the preferred embodiment, the fixed end 233 is bolted onto the structural hub 1 to create a non-separable engagement between the linear actuator 23 and the structural hub 1. In contrast, the actuation end 234 may be pivotally mounted onto the extension arm 22 to prevent compound forces from acting on the linear actuator 23. Finally, the structural hub 1 is releasably tethered to the hitch system 3. More specifically, the hitch system 3 is used to connect the present invention onto the wire, rope, or strap of a crane, whereby the present invention can be vertically hoisted and transported to the desired position.

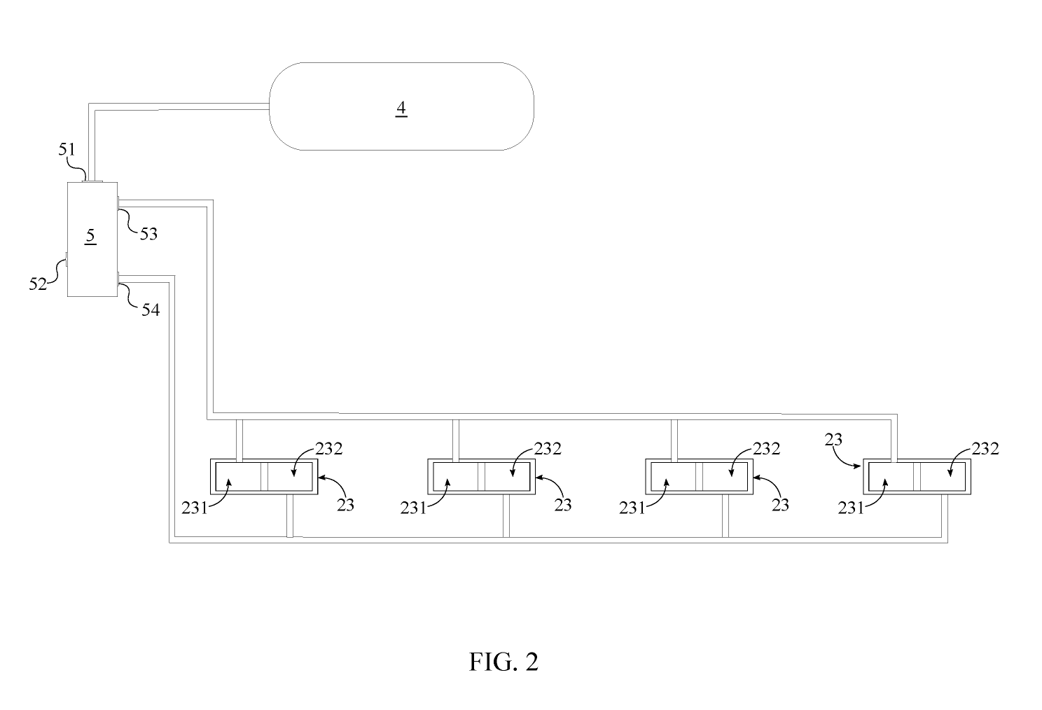

In reference to FIG. 2, the preferred embodiment of the linear actuator 23 of the plurality of gripping mechanisms 2 is powered by a pressure generator 4. Preferably, the pressure generator 4 is a pneumatic device that supplies pressurized air to extend or retract the linear actuator 23. A user can control the extension and retraction of the linear actuator 23 with a valve 5. The preferred valve 5 comprises an inlet 51, an exhaust port 52, a first outlet 53, and a second outlet 54. The valve 5 further comprises a lever or a similar actuation mechanism, which when actuated, can divert pressurized air entering the inlet 51 to the first outlet 53 or the second outlet 54. Similarly, the lever can also connect the exhaust port 52 to the first outlet 53 or the second outlet 54. The linear actuator 23 comprises an inward force-inducing chamber 231 and an outward force-inducing chamber 232. More specifically, the preferred embodiment of the linear actuator 23 is a double-action cylinder. The double-action cylinder is partitioned into the inward force-inducing chamber 231 and the outward force-inducing chamber 232 by a piston. A piston-rod connected to the piston extends out of the double-action cylinder. The end of the piston-rod is defined as the actuation end 234 of the linear actuator 23 which attaches to the extension arm 22. Thus, the extension or retraction of the piston-rod, likewise causes the extension or retraction of the extension arm 22. Both the inward force-inducing chamber 231 and the outward force-inducing chamber 232 can be individually filled with pressurized air from the pressure generator 4. As such, the pressure generator 4 is in fluid communication with the inlet 51. Further, the first outlet 53 is in fluid communication with the inward force-inducing chamber 231 for each of the plurality of gripping mechanisms 2.

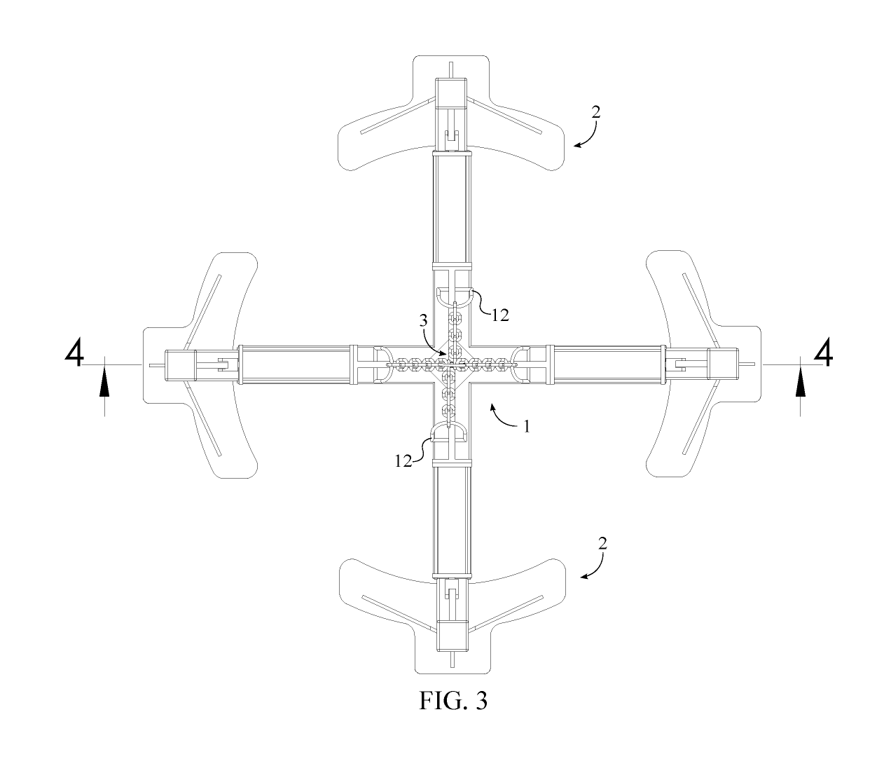

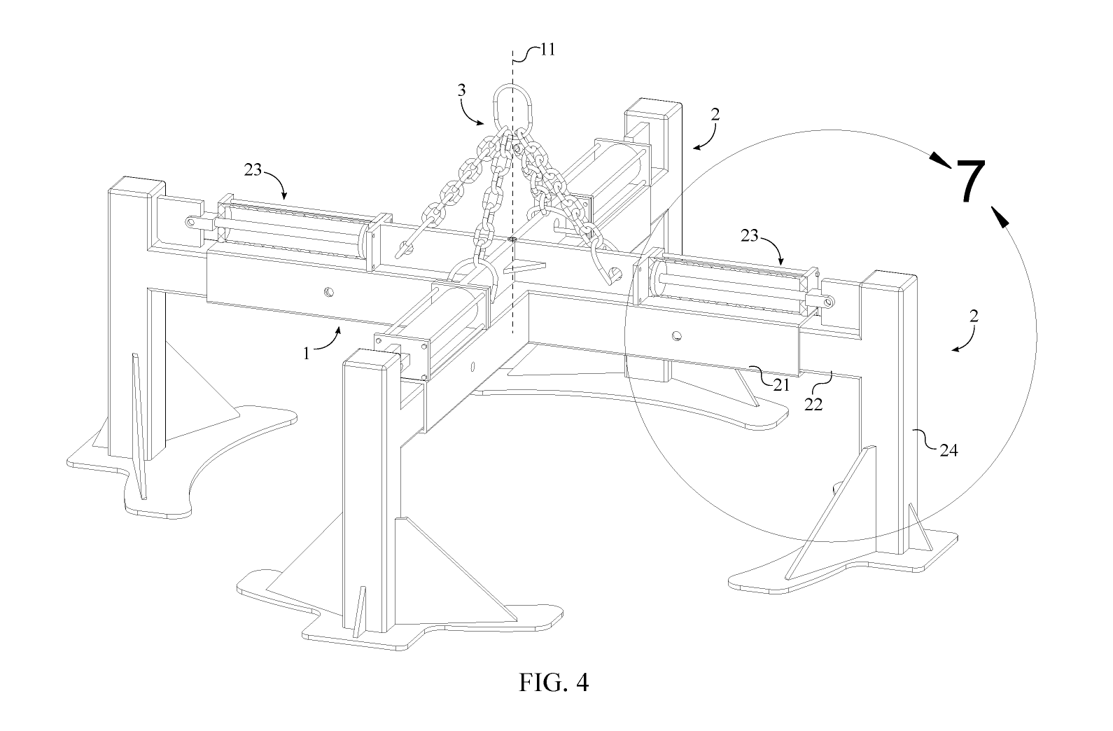

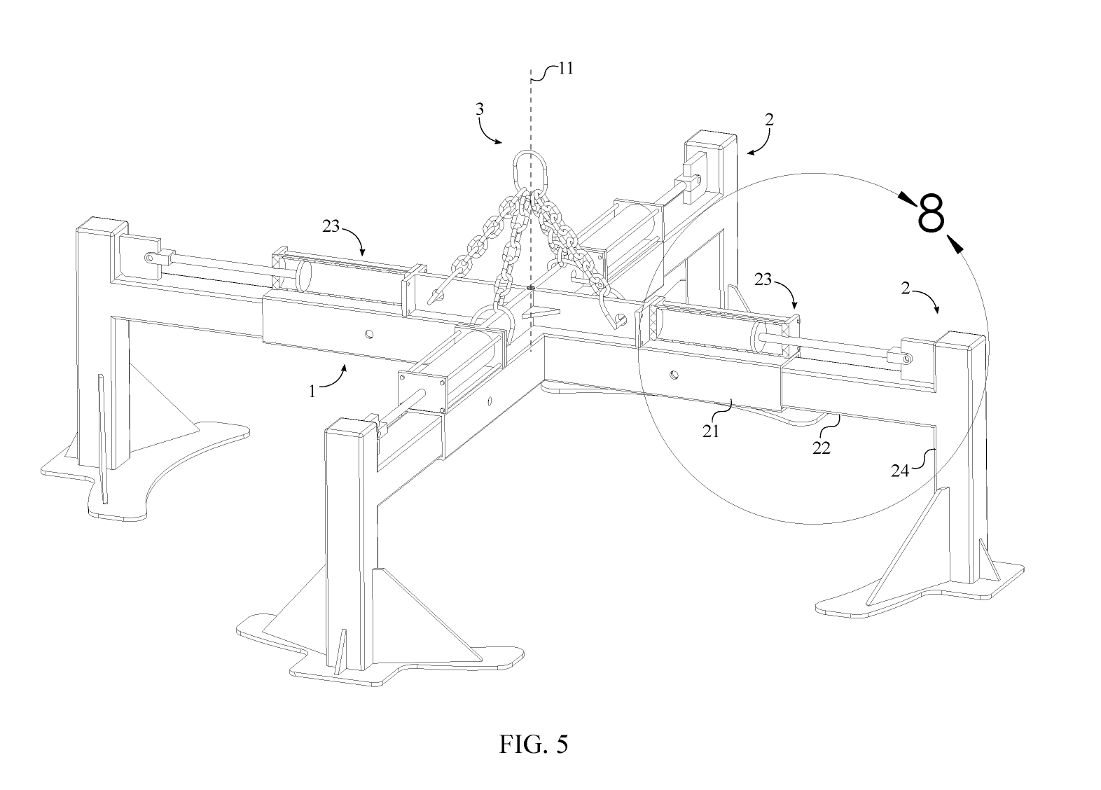

In reference to FIG. 3-FIG. 5, the user turns the lever of the valve 3 a first arbitrary direction to retract the linear actuator 23 and thus the extension arm 22. Turning the lever in the first arbitrary direction causes pressurized air to be diverted from the inlet 51 to the first outlet 53. This fills the inward force-inducing chamber 231 with pressurized air and causes the piston to move into the outward force-inducing chamber 232, which pulls the piston-rod into the double-action cylinder. Similarly, the second outlet 54 is in fluid communication with the outward force-inducing chamber 232 for each of the plurality of gripping mechanisms 2. To extend the linear actuator 23, the user turns the lever a second arbitrary direction, opposite the first arbitrary direction, which causes pressurized air to be diverted from the inlet 51 to the second outlet 54. The fluid communication allows pressurized air to circulate from the second outlet 54 to the outward force-inducing chamber 232 of the linear actuator 23 of the plurality of gripping mechanisms 2. The piston is thus forced to move into the inward force-inducing chamber 231, which extends the piston rod out of the double-action cylinder.

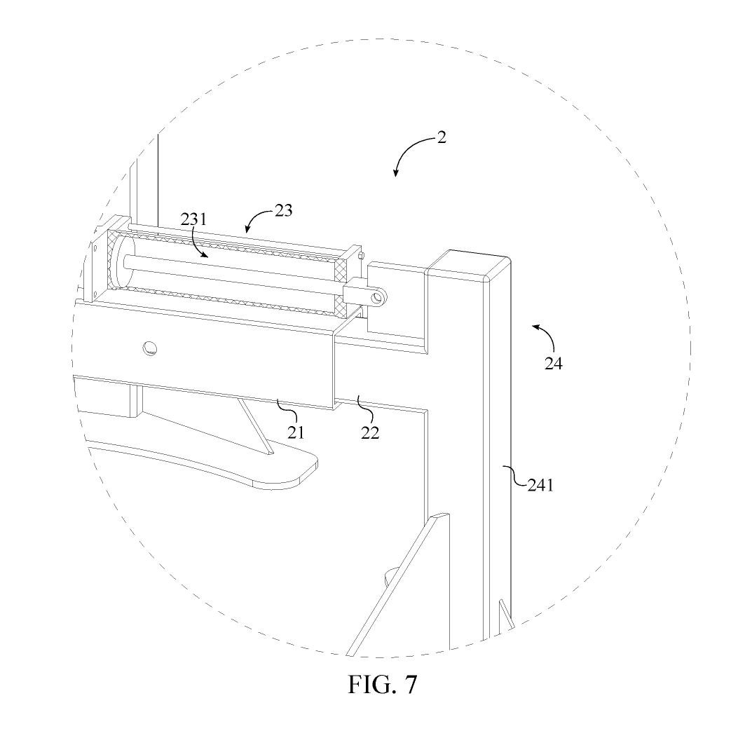

This mechanism is used transition the plurality of gripping mechanisms 2 between a retracted configuration and an extended configuration. As can be seen in FIG. 2 and FIG. 7, the retracted configuration retracts the linear actuator 23 of the plurality of gripping mechanisms 2, whereby the gripper 24 slides under the flange and vertically supports the concrete structure. Accordingly, the retracted configuration requires the inlet 51 to be in fluid communication with the inward force-inducing chamber 231 for each of the plurality of gripping mechanisms 2. More precisely, the valve 5 opens the passage between the first outlet 53 and the inlet 51, while blocking the passage between the second outlet 54 and the inlet 51. This allows pressurized air to flow from the pressure generator 4 into the inward force-inducing chamber 231 via the first outlet 53. In the same vein, the exhaust port 52 is placed into fluid communication with the outward force-inducing chamber 232 for each of the plurality of gripping mechanisms 2 through the second outlet 54. More precisely, the valve 5 opens the passage between the exhaust port 52 and the second outlet 54, while blocking the passage between the exhaust port 52 and the first outlet 53. Pressurized air trapped in the outward force-inducing chamber 232 thus escapes into the atmosphere, thereby creating an area of lower pressure in the outward force-inducing chamber 232 and an area of higher pressure in the inward force-inducing chamber 231. This forces the piston into the outward force-inducing chamber 232.

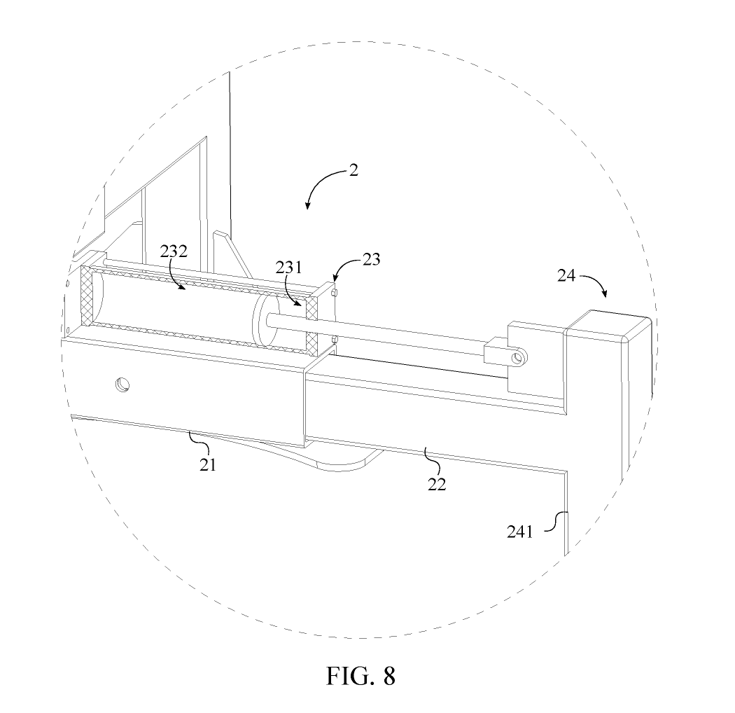

As can be seen in FIG. 2 and FIG. 8, to detach the plurality of gripping mechanisms 2 from the concrete structure, the extension arm 22 for each of the plurality of gripping mechanisms 2 is placed in an extended configuration. In the extended configuration, the gripper 24 of the plurality of gripping mechanisms 2 separates from the flange, thereby allowing the concrete structure to be detached from the present invention. Accordingly, the inlet 51 is in fluid communication with the outward force-inducing chamber 232 for each of the plurality of gripping mechanisms 2 through the second outlet 54. More precisely, the valve 5 opens the passage between the second outlet 54 and the inlet 51, while blocking the passage between the first outlet 53 and the inlet 51. Pressurized air travels from the pressure generator 4, through the second outlet 54, into the outward force-inducing chamber 232, thereby pushing the piston into the inward force-inducing chamber 231. Similarly, the exhaust port 52 is placed in fluid communication with the inward force-inducing chamber 231 for each of the plurality of gripping mechanisms 2 through the first outlet 53. In the extended configuration, the valve 5 opens the passage between the exhaust port 52 and the first outlet 53, while blocking the passage between the exhaust port 52 and the second outlet 54. Pressurized air trapped in the inward force-inducing chamber 231 thus escapes into the atmosphere, thereby creating an area of lower pressure in the inward force-inducing chamber 231 and an area of higher pressure in the outward force-inducing chamber 232. This forces the piston into the inward force-inducing chamber 231. As such, the linear actuator 23 of the plurality of gripping mechanisms 2 extends outward and increases the effective span of the present invention. Further, increasing the span of the plurality of gripping mechanisms 2 also allows the concrete structure to easily fit into the plurality of gripping mechanisms 2.

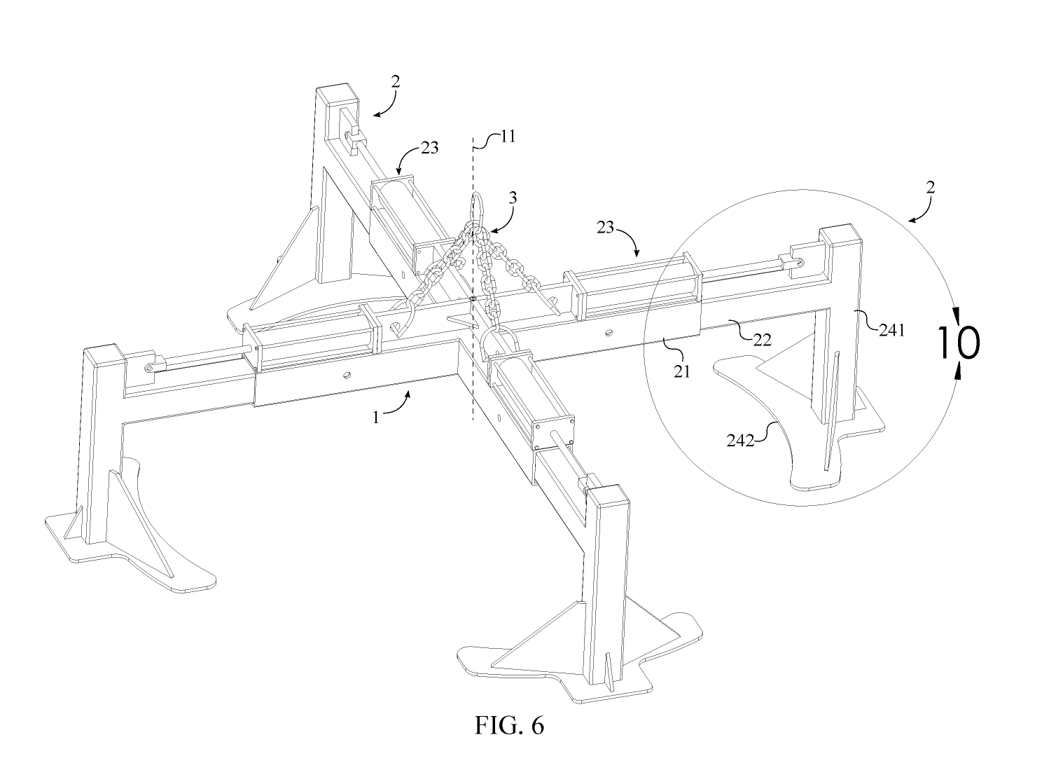

In reference to FIG. 6, the preferred embodiment of the gripper 24 comprises an extension leg 241 and a footplate 242. The gripper 24 is designed to brace the flange and provide lateral and vertical support. Preferably, the extension leg 241 is terminally connected to the extension arm 22, offset from the sleeve 21, whereby the extension leg 241 presses the sidewall of the flange. Further, the extension leg 241 is positioned parallel to the central axis 11 of the structural hub 1, ensuring the flange is equally supported by the plurality of gripping mechanisms 2. The footplate 242 is terminally connected to the extension leg 241, offset from the extension arm 22. The flange of the concrete structure is positioned inside the gap between the footplate 242 and the extension arm 22. Since the sidewall of the flange is perpendicular to the bottom surface, the footplate 242 is positioned normal to the central axis 11 of the structural hub 1. Once engaged, the footplate 242 pushes upward against the bottom surface of the flange whereas the extension leg 241 pushes the sidewall inwards towards the central axis 11. This arrangement ensures that the concrete structure remains aligned to the central axis 11, allowing the user to accurately place the concrete structure in the desired position.

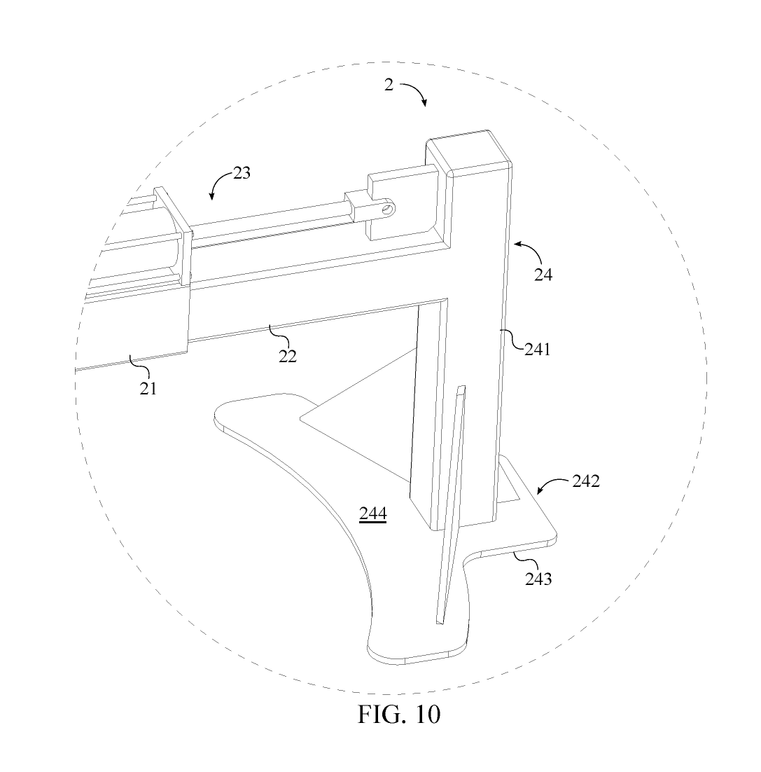

In reference to FIG. 10, the footplate 242 is designed to brace the arcuate sides of the concrete structure. As such, the footplate 242 comprises a flange portion 243 and an arcuate portion 244. The flange portion 243 is terminally connected to the extension leg 241, offset from the extension arm 22. The flange fits into the gap created by the offset between the extension arm 22 and the footplate 242. As a result, the flange is pushed upwards by the flange portion 243 at the bottom, and pushed inwards by the extension leg 241 at the side. This is possible because the arcuate portion 244 is positioned adjacent to the flange portion 243. Further, the arcuate portion 244 is also positioned adjacent to the flange portion 243, which allows the footplate 242 to simultaneously support the flange and the side of the concrete structure which are oriented perpendicular to each other. Finally, the arcuate portion 244 is oriented concave to the central axis 11 of the structural hub 1. As a result, the plurality of gripping mechanisms 2 forms a circular slot which braces the sides of the concrete structure.

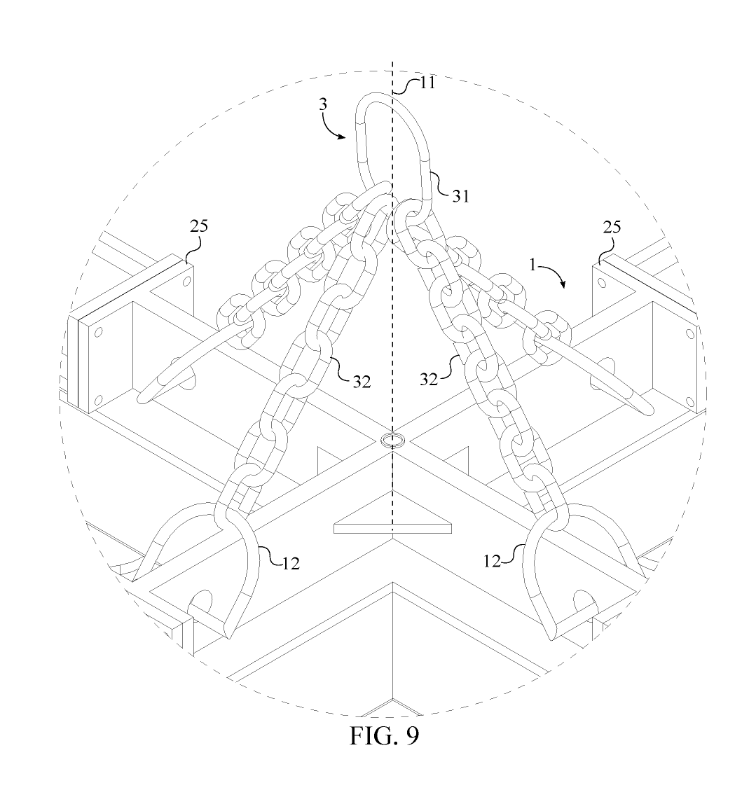

In reference to FIG. 9, the preferred embodiment of the structural hub 1 is designed to withstand shear and bending forces generated by the concrete structure pushing down on the plurality of gripping mechanisms 2. More specifically, the structural hub 1 comprises a plurality of elongated members 25 for increasing structural rigidity. The plurality of elongated members 25 is radially positioned around the central axis 11 of the structural hub 1. Preferably, there are four elongated members positioned at right angles to each other. The sleeve 21 for each of the plurality of gripping mechanisms 2 is laterally connected to a corresponding member from the plurality of elongated members 25. The preferred embodiment of the sleeve 21 is a hollow tube that is susceptible to bend under the load of the extension arm 22. To prevent this, the corresponding member is aligned longitudinal to the sleeve 21, thereby making the sleeve 21 more resistant to load forces.

The plurality of elongated members 25 also provides a fastening point for the hitch system 3. The preferred embodiment of the hitch system 3 comprises a primary link 31 and a plurality of secondary links 32. The primary link 31 fastens the plurality of secondary links 32 to the rope or a wire on a crane. The plurality of secondary links 32 is radially positioned around the central axis 11 of the structural hub 1. This equally distributes the lift forces to the plurality of secondary links 32. The plurality of secondary links 32 is radially coupled around the primary link 31. More specifically, the plurality of secondary links 32 is constructed out of interlinking chain links. The distal chain-link of the plurality of secondary links 32 interlinks with the primary link 31, thereby forming inseparable connection. Further, each of the plurality of elongated members 25 is tethered to a corresponding link from the plurality of secondary links 32. More specifically, each of the plurality of elongated members 25 comprises an eye that interlinks with the corresponding link. The eye is preferably drilled laterally into each of the plurality of elongated members 25. In the preferred embodiment of the present invention, there are four secondary links that each connect to one of the four elongated members. However, the number of elongated members may change in alternate embodiments of the present invention.

The structural hub 1 may further comprise a plurality of clevises 12. Preferably, the plurality of clevises 12 is a U-shaped element with a pin going through the end that closes the opening. Each of the plurality of elongated members 25 is rotatably mounted into a corresponding clevis from the plurality of clevises 12. More specifically, the eye of each of the plurality of elongated members 25 is traverses through the pin of the corresponding clevis, thereby interlocking the each of the plurality of elongated members 25 to the corresponding clevis. The plurality of devises 12 is also used to connect the fasten the hitch system 3 to the support structure. Accordingly, each of the plurality of secondary links 32 is coupled to the corresponding clevis. More specifically, the proximal chain-link of each of the plurality of secondary links 32 interlinks with the U-shaped element of the corresponding clevis. Once the hitch system 3 is secured, the crane connects to the primary link 31 and lifts the present invention to the desired position.

Although the invention has been explained in relation to its preferred embodiment, it is to be understood that many other possible modifications and variations can be made without departing from the spirit and scope of the invention as hereinafter claimed.

What is claimed is:

1. A lifting device for precast concrete structures comprises:
a structural hub;
a plurality of gripping mechanisms;
a hitch system;
each of the plurality of gripping mechanisms comprises a sleeve, an extension arm, a linear actuator, and a gripper;
the plurality of gripping mechanisms being radially positioned around a central axis of the structural hub;
the structural hub being terminally and laterally connected to the sleeve;
the sleeve being positioned perpendicular to the central axis of the structural hub;
the extension arm being slidably mounted into the sleeve, opposite the structural hub;
the gripper being terminally connected to the extension arm, offset from the sleeve;
a fixed end of the linear actuator being laterally connected to the sleeve;
an actuation end of the linear actuator being laterally connected to the extension arm; and
the structural hub being releasably tethered to the hitch system.

2. The lifting device for precast concrete structures as claimed in claim 1 comprises:
a pressure generator;
a valve;
the valve comprises an inlet, an exhaust port, a first outlet, and a second outlet;
the linear actuator comprises an inward force-inducing chamber and an outward force-inducing chamber;
the pressure generator being in fluid communication with the inlet;
the first outlet being in fluid communication with the inward force-inducing chamber for each of the plurality of gripping mechanisms; and
the second outlet being in fluid communication with the outward force-inducing chamber for each of the plurality of gripping mechanisms.

3. The lifting device for precast concrete structures as claimed in claim 2 comprises:
wherein the extension arm for each of the plurality of gripping mechanisms is in a retracted configuration;
the inlet being in fluid communication with the inward force-inducing chamber for each of the plurality of gripping mechanisms through the first outlet; and
the exhaust port being fluid communication with the outward force-inducing chamber for each of the plurality of gripping mechanisms through the second outlet.

4. The lifting device for precast concrete structures as claimed in claim 2 comprises:
wherein the extension arm for each of the plurality of gripping mechanisms is in an extended configuration;
the inlet being in fluid communication with the outward force-inducing chamber for each of the plurality of gripping mechanisms through the second outlet; and
the exhaust port being fluid communication with the inward force-inducing chamber for each of the plurality of gripping mechanisms through the first outlet.

5. The lifting device for precast concrete structures as claimed in claim 1 comprises:
the gripper comprises an extension leg and a footplate;
the extension leg being terminally connected to the extension arm, offset from the sleeve;
the extension leg being positioned parallel to the central axis of the structural hub;
the footplate being terminally connected to the extension leg, offset from the extension arm;
the footplate being oriented towards the central axis of the structural hub; and
the footplate being positioned normal to the central axis of the structural hub.

6. The lifting device for precast concrete structure as claimed in claim 5 comprises:
the footplate comprises a flange portion and an arcuate portion;
the flange portion being terminally connected to the extension leg, offset from the extension arm;
the arcuate portion being positioned adjacent to the flange portion; and
the arcuate portion being oriented concave to the central axis of the structural hub.

7. The lifting device for precast concrete structure as claimed in claim 1 comprises:
the structural hub comprises a plurality of elongated members;
the plurality of elongated members being radially positioned around the central axis of the structural hub; and
the sleeve for each of the plurality of gripping mechanisms being laterally connected to a corresponding member from the plurality of elongated members.

8. The lifting device for precast concrete structure as claimed in claim 1 comprises:
the structural hub comprises a plurality of elongated members;
the hitch system comprises a primary link and a plurality of secondary links;
the plurality of elongated members being radially positioned around the central axis of the structural hub;
the plurality of secondary links being radially coupled around the primary link; and
each of the plurality of elongated members being tethered to a corresponding link from the plurality of secondary links.

9. The lifting device for precast concrete structure as claimed in claim 8 comprises:
the structural hub further comprises a plurality of clevises;
each of the plurality of elongated members being rotatably mounted into a corresponding clevis from the plurality of clevises; and
each of the plurality of secondary links being coupled to the corresponding clevis.

10. A lifting device for precast concrete structures comprises:
a structural hub;
a plurality of gripping mechanisms;
a hitch system;
a pressure generator;
a valve;
each of the plurality of gripping mechanisms comprises a sleeve, an extension arm, a linear actuator, and a gripper;
the valve comprises an inlet, an exhaust port, a first outlet, and a second outlet;
the plurality of gripping mechanisms being radially positioned around a central axis of the structural hub;
the structural hub being terminally and laterally connected to the sleeve;
the sleeve being positioned perpendicular to the central axis of the structural hub;
the extension arm being slidably mounted into the sleeve, opposite the structural hub;
the gripper being terminally connected to the extension arm, offset from the sleeve;
a fixed end of the linear actuator being laterally connected to the sleeve;
an actuation end of the linear actuator being laterally connected to the extension arm;
the structural hub being releasably tethered to the hitch system;
the linear actuator comprises an inward force-inducing chamber and an outward force-inducing chamber;
the pressure generator being in fluid communication with the inlet;
the first outlet being in fluid communication with the inward force-inducing chamber for each of the plurality of gripping mechanisms; and
the second outlet being in fluid communication with the outward force-inducing chamber for each of the plurality of gripping mechanisms.

11. The lifting device for precast concrete structures as claimed in claim 10 comprises:
wherein the extension arm for each of the plurality of gripping mechanisms is in a retracted configuration;
the inlet being in fluid communication with the inward force-inducing chamber for each of the plurality of gripping mechanisms through the first outlet; and
the exhaust port being fluid communication with the outward force-inducing chamber for each of the plurality of gripping mechanisms through the second outlet.

12. The lifting device for precast concrete structures as claimed in claim 10 comprises:
wherein the extension arm for each of the plurality of gripping mechanisms is in an extended configuration;
the inlet being in fluid communication with the outward force-inducing chamber for each of the plurality of gripping mechanisms through the second outlet; and
the exhaust port being fluid communication with the inward force-inducing chamber for each of the plurality of gripping mechanisms through the first outlet.

13. The lifting device for precast concrete structures as claimed in claim 10 comprises:
the gripper comprises an extension leg and a footplate;
the footplate comprises a flange portion and an arcuate portion;
the extension leg being terminally connected to the extension arm, offset from the sleeve;
the extension leg being positioned parallel to the central axis of the structural hub;
the footplate being terminally connected to the extension leg, offset from the extension arm;
the footplate being oriented towards the central axis of the structural hub;
the footplate being positioned normal to the central axis of the structural hub;
the flange portion being terminally connected to the extension leg, offset from the extension arm;
the arcuate portion being positioned adjacent to the flange portion; and
the arcuate portion being oriented concave to the central axis of the structural hub.

14. The lifting device for precast concrete structure as claimed in claim 10 comprises:
the structural hub comprises a plurality of elongated members;
the plurality of elongated members being radially positioned around the central axis of the structural hub; and
the sleeve for each of the plurality of gripping mechanisms being laterally connected to a corresponding member from the plurality of elongated members.

15. The lifting device for precast concrete structure as claimed in claim 10 comprises:
the structural hub comprises a plurality of elongated members;
the hitch system comprises a primary link and a plurality of secondary links;
the plurality of elongated members being radially positioned around the central axis of the structural hub;
the plurality of secondary links being radially coupled around the primary link; and
each of the plurality of elongated members being tethered to a corresponding link from the plurality of secondary links.

16. The lifting device for precast concrete structure as claimed in claim 15 comprises:
the structural hub further comprises a plurality of clevises;
each of the plurality of elongated members being rotatably mounted into a corresponding clevis from the plurality of clevises; and
each of the plurality of secondary links being coupled to the corresponding clevis.
